(19) United States
(12) Patent Application Publication
(10) Pub. No.: US 2010/0165497 A1
(43) Pub. Date: Jul. 1, 2010

(54) STORAGE APPARATUS, CONTROL APPARATUS, AND CONTROL METHOD

(75) Inventor: Masashi WAKISAKA, Fussa-shi (JP)

Correspondence Address: KNOBBE MARTENS OLSON & BEAR LLP, 2040 MAIN STREET, FOURTEENTH FLOOR, IRVINE, CA, 92614, US

(73) Assignee: TOSHIBA STORAGE DEVICE CORPORATION, Tokyo (JP)

(21) Appl. No.: 12/645,370

(22) Filed: Dec. 22, 2009

(30) Foreign Application Priority Data
Dec. 26, 2008 (JP) 2008-333359

(51) Int. Cl. G11B 27/36

(52) U.S. Cl. 360/31; G9B/27.052

(57) ABSTRACT

According to one embodiment, a storage apparatus includes: a reader configured to read a sector recorded in a storage medium; a detector configured to detect a sync mark in the sector; a determiner configured to determine the position of the data region of the sector based on the sync mark detected by the detector; a data generator configured to generate data of the data region based on the data region, the position of the data region being determined by the determiner; a first judging module configured to judge whether the data generated by the data generator is normal; and a data compartment recorder configured to record a data compartment in the storage medium distinguishably from other data compartments, the recorded data compartment comprising a data region from which, among the data generated by the data generator, data judged as abnormal is generated.

### CROSS-REFERENCE TO RELATED APPLICATIONS

This application is based upon and claims the benefit of priority from Japanese Patent Application No. 2008-333359, filed Dec. 26, 2008, the entire contents of which are incorporated herein by reference.

### BACKGROUND

1. Field

One embodiment of the invention relates to a technology for managing data on a storage medium.

2. Description of the Related Art

In storage apparatuses, such as hard disks, data is generally read and written per sector. A sector in a conventional hard disk will be hereinafter described with reference to the accompanying drawings. FIG. 7 illustrates one example of a sector in a conventional hard disk.

As illustrated in FIG. 7, in the conventional hard disk, data is read and written per sector. In each sector, a preamble, a first sync mark (sync byte), a second sync mark, data, and an error correcting code (ECC) are arranged. The preamble is a pattern having a constant period, and is used to adjust timing of a read gate and a phase when data is read. The first sync mark indicates a head of the data in the sector. The second sync mark is a preliminary sync mark that is used when the first sync mark is failed to be read. The sync mark may be one or more in one sector. The data is written user data (or system data). The ECC is a code that is used to correct an error of the data in a corresponding sector.

When an occupancy ratio of the preamble, the sync mark, and the ECC with respect to the data in one sector increases, a recording ratio of the data with respect to the preamble and the like essentially decreases. As a result, the amount of data substantially recorded in a storage medium of the hard disk may decrease so as to deteriorate efficiency of the storage medium. On the other hand, in order to avoid such deterioration, a format (configuration of sectors) in which a plurality of sectors is collected as one long sector has been known. In the following, in order to distinguish this long sector from a later described long sector, this long sector is referred to as a long sector A. FIG. 8 illustrates an example of the long sector A in a conventional hard disk.

The long sector A illustrated in FIG. 8 has the same configuration as that of the sector illustrated in FIG. 7. However, when a recording density of a storage medium in the long sector A is the same as that in the sector illustrated in FIG. 7, an occupancy ratio of a preamble, a sync mark, and an ECC with respect to data is small as compared to the sector illustrated in FIG. 7. Accordingly, in the format illustrated in FIG. 8, the amount of data recorded in a certain region is large and data recording is performed efficiently, as compared to the format illustrated in FIG. 7.

However, in the format illustrated in FIG. 8, data before the second sync mark cannot be read when there is a defect on the sync mark, as described in the following. FIGS. 9 and 10 illustrate the long sector A with the defect.

As illustrated in FIG. 9, when there is the defect on the first sync mark in the long sector A, the data after the second sync mark is read during the data reading, but the data before the second sync mark is not read. In addition, as illustrated in FIG. 10, when there is a defect over all sync marks (first and second sync marks) in the long sector A, the sync marks are not read so that a head of the data cannot be detected. As a result, the entire data in the long sector is not read. On the other hand, in order to avoid the entire data from not being read, a long sector with a plurality of pieces of data coupled with each other, where sync marks and ECCs are attached to the pieces of data, has been known. In the following, in order to distinguish this long sector from the above-described long sector A, this long sector described is referred to as a long sector B. FIG. 11 illustrates the long sector B in a conventional hard disk. FIG. 12 illustrates the long sector B with a defect on a sync mark.

In the long sector B illustrated in FIG. 11, pieces of data (n pieces of data in FIG. 11) each of which with a preamble attached to a head thereof and with a sync mark and an ECC attached to the subsequent positions are arranged. According to this format, only a portion of the data in the long sector B can be read. For example, when only data 2 needs to be read, a phase and timing of a read gate are first adjusted by the preamble of the head in the long sector B, and a delay from the preamble to a second sync mark and a window are set so as to detect the second sync mark. As a result, only the data 2 can be read. When a certain sync mark (for example, the second sync mark) cannot be detected, data corresponding to the certain sync mark can be read by calculation based on a previous sync mark (for example, the first sync mark) in the long sector B. Specifically, a head position of the data to which the undetected sync mark is attached is calculated on the basis of the previous sync mark, and the data corresponding to the undetected sync mark is read using the head position of the data corresponding to the previous sync mark as a head position of the data corresponding to the undetectable sync mark.

However, as illustrated in FIG. 12, when the sync mark (first sync mark) of the head is not detected, there exists no previous sync mark in the long sector B. In this case, the data corresponding to the sync mark of the head cannot be read. On the other hand, in order to avoid the aforementioned case, reading data corresponding to the sync mark of the head from a detection position of anyone of subsequent sync marks in the long sector has been known (for example, see Japanese Patent No. 3835495). Specifically, data sampling from the sync mark of the head is stored in a memory, a head position of the data is calculated based on the detection position of any one of subsequent sync marks in the long sector, and data corresponding to the sync mark of the head is read. This technology can be applied to the following case. FIGS. 13 and 14 illustrate the long sector B with a defect that disables reading of data.

According to the above-described technology, as illustrated in FIG. 13, when there is a defect over the entire portion of data in the long sector B, the data with the defect cannot be read, but other data can be read. In addition, as illustrated in FIG. 14, when there is a defect over the entire portion of the data and the ECC thereof in the long sector B, the other data can be read, similar to the above case.

However, as illustrated in FIGS. 13 and 14, when the long sector B with the defect is registered as the long sector B with data that cannot be read, readable data in the long sector B may be handled as data that cannot be read. In addition, use efficiency of a data region of a storage medium may be lowered by handling data per long sector B, because the data region of the storage medium is managed per long sector B.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary view of a storage apparatus according to an embodiment of the invention;

FIG. 2 is an exemplary view of a format of data in the embodiment;

FIG. 3 is an exemplary view of a defect management table in the embodiment;

FIG. 4 is an exemplary view of the storage apparatus in the embodiment;

FIG. 5 is a flowchart of a defect registering process in the embodiment;

FIG. 6 is a flowchart of the defect registering process in the embodiment;

FIG. 7 is an exemplary view of a sector in one conventional hard disk;

FIG. 8 is an exemplary view of a long sector A in other conventional hard disk;

FIG. 9 is an exemplary view of the long sector A with one defect;

FIG. 10 is an exemplary view of the long sector A with other defect;

FIG. 11 is an exemplary view of a long sector B in other conventional hard disk;

FIG. 12 is an exemplary view of the long sector B with one defect a sync mark;

FIG. 13 is an exemplary view of the long sector B with other defect that disables a read operation of data; and

FIG. 14 is an exemplary view of the long sector B with other defect that disables reading of data.

### DETAILED DESCRIPTION

Various embodiments according to the invention will be described hereinafter with reference to the accompanying drawings. In general, according to one embodiment of the invention, a storage apparatus is configured to record a sector in a storage medium. The sector includes a plurality of data compartments. Each of the data compartments includes a data region in which a piece of data is recorded and a sync mark configured to indicate a position of the data region. The storage apparatus includes: a reader configured to read the sector recorded in the storage medium; a detector configured to detect the sync mark in the sector read by the reader; a determiner configured to determine the position of the data region of the sector read by the reader based on the sync mark detected by the detector; a data generator configured to generate data of the data region based on the data region, the position of the data region being determined by the determiner; a first judging module configured to judge whether the data generated by the data generator is normal; and a data compartment recorder configured to record a data compartment in the storage medium distinguishably from other data compartments, the recorded data compartment comprising a data region from which, among the data generated by the data generator, data judged as abnormal is generated.

According to another embodiment of the invention, a control apparatus of a storage apparatus configured to record a sector in a storage medium, the sector comprising a plurality of data compartments, each of the data compartments comprising a data region in which a piece of data is recorded and a sync mark configured to indicate a position of the data region, the control apparatus comprises: a detector configured to control a read channel of the storage apparatus to detect the sync mark in the sector read by a reader of the storage apparatus; a determiner configured to control the read channel to determine the position of the data region of the sector read by the reader based on the sync mark detected by the detector; a data generator configured to generate data of the data region based on the data region, the position of the data region being determined by the determiner; a first judging module configured to judge whether the data generated by the data generator is normal; and a data compartment recorder configured to control a storage module of the storage apparatus to record a data compartment in the storage medium distinguishably from other data compartments, the recorded data compartment comprising a data region from which, among the data generated by the data generator, data judged as abnormal is generated.

According to still another embodiment of the invention, a control method of a storage apparatus configured to record a sector in a storage medium, the sector comprising a plurality of data compartments, each of the data compartments comprising a data region in which a piece of data is recorded and a sync mark configured to indicate a position of the data region, the control method comprises: reading the sector recorded in the storage medium; detecting the sync mark in the sector read by the reader; determining the position of the data region of the sector read by the reading based on the sync mark detected by the detecting; generating data of the data region based on the data region, the position of the data region being determined by the determining; first judging whether the data generated by the generating is normal; and recording a data compartment in the storage medium distinguishably from other data compartments, the recorded data compartment comprising a data region from which, among the data generated by the generating, data judged as abnormal is generated.

Embodiments according to the invention will be described hereinafter with reference to the accompanying drawings.

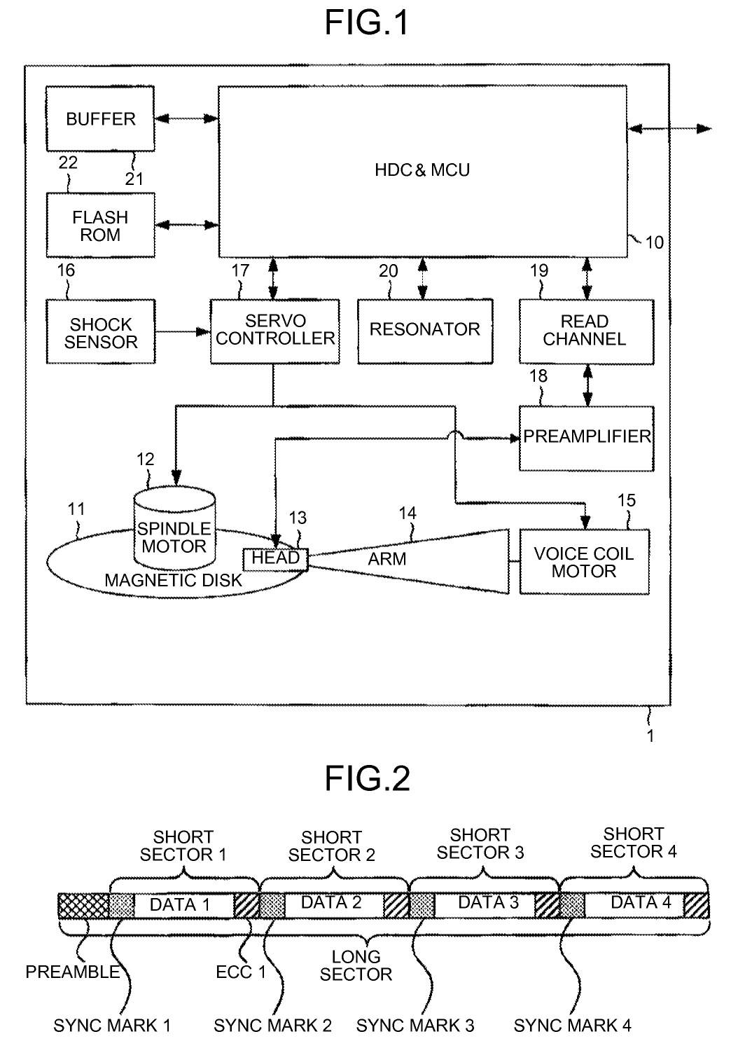

First, a hardware configuration of a storage apparatus according to one embodiment of the invention will be described. FIG. 1 illustrates the hardware configuration of a storage apparatus according to an embodiment of the invention.

A storage apparatus 1 according to the embodiment is a hard disk that writes data in a magnetic storage medium (magnetic disk 11 to be described in detail below). The storage apparatus 1 comprises, as hardware, an hard disk controller & micro control unit (HDC&MCU) 10 functioning as a control device, a magnetic disk 11 (storage medium), a spindle motor 12, a head 13 (a reader and a recorder), an arm 14, a voice coil motor 15, a shock sensor 16, a servo controller 17, a preamplifier 18, a read channel 19 (detector), a resonator 20, a buffer 21, and a flash ROM 22.

The HDC&MCU controls the entire storage apparatus 1. The magnetic disk 11 is a storage medium to which data is written. The spindle motor 12 rotates the magnetic disk 11. The head 13 reads and writes data with respect to the magnetic disk 11. The arm 14 supports the head 13. The voice coil motor 15 drives the arm 14 to change a position of the head 13 with respect to the magnetic disk 11. The shock sensor 16 is a sensor that detects disturbance of the storage apparatus 1. The servo controller 17 controls the spindle motor 12 and the voice coil motor 15, on the basis of the detection of the disturbance by the shock sensor 16 and an instruction of the HDC&MCU 10. The preamplifier 18 amplifies a signal that is read by the head 13 and a signal that is written by the head 13. The read channel 19 demodulates a code of the read signal amplified by the preamplifier 18, modulates a code of the written data, detects a sync mark, and determines a position of a data region based on the sync mark. The resonator 20 determines a frequency of a signal when data is written and read. The buffer 21 is a memory in which data read and written in the magnetic disk 11 is temporarily stored. The flash read only memory (ROM) 22 is a non-volatile memory.

Next, a format of data that is read and written in the magnetic disk 11 will be described. FIG. 2 illustrates a format of data in the embodiment.

As illustrated in FIG. 2, according to the format of the data in the embodiment, a long sector (sector) is used as unit data. The long sector comprises a plurality of short sectors (data compartments) and a preamble disposed to a head of the short sectors. Each of the short sectors comprise data (data region) to which a sync mark is attached to a head thereof and an error correcting code (ECC) is attached to a tail. The configuration of the long sector is the same as that of the long sector B. In each of the short sectors, a short sector number that is a sector number different from a sector number allocated to the long sector is allocated. The short sector number is a series of continuous number used to distinguish the short sectors comprised in all of the long sectors in the data regions on the magnetic disk 11 from each other, and are represented by hexadecimal numbers. In the embodiment illustrated in FIG. 2, it is assumed that each long sector comprises four short sectors. In the description below, the four short sectors are a short sector 1, a short sector 2, a short sector 3, and a short sector 4, in this order from a preamble side. A sync mark 1 and data 1 are allocated to the short sector 1. Similarly, a sync mark 2 and data 2 are allocated to the short sector 2, a sync mark 3 and data 3 are allocated to the short sector 3, and a sync mark 4 and data 4 are allocated to the short sector 4. That is, numbers of the components that are comprised in the short sectors follow the numbers of the short sectors.

As such, if the numbers are allocated to the short sectors comprised in the long sector, data written in the storage medium can be managed per short sector, not per long sector. That is, since the data is handled per short sector during data reading, use efficiency of the data region of the storage medium is improved.

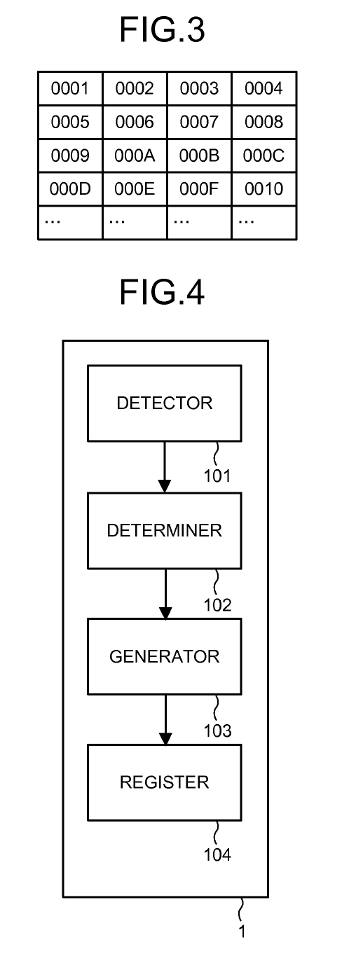

Next, a defect management table will be described. FIG. 3 illustrates a defect management table.

The defect management table illustrated in FIG. 3 is a management table in which short sector numbers are recorded. The defect management table is stored in a system region of the magnetic disk 11, and is read into the flash ROM 22 during the booting. Besides, the defect management table may be stored in the flash ROM 22 in advance, instead of the system region. In other words, the defect management table can be stored in any location as long as the defect management table is kept held even when power of the storage apparatus 1 is off. The short sector number that is written in the defect management table indicates a number of a short sector with a defect, and is registered by defect registering process described in detail below.

The configuration of the storage apparatus according to the embodiment will be described. FIG. 4 illustrates the functional configuration of the storage apparatus in the embodiment.

As illustrated in FIG. 4, the storage apparatus 1 in the embodiment comprises a detector 101 (a reader, a detector, and a second judging module), a determiner 102, a generator 103 (a data generator and a first judging module), and a register 104 (data compartment recorder). The detector 101 detects a sync mark in the long sector. The determiner 102 determines a head of the long sector by the read channel 19, on the basis of the sync mark. The generator 103 demodulates a code of the data in the short sector by the read channel 19, and generates data from the data whose code has been demodulated. The register 104 registers a number of a short sector comprising data that cannot be generated due to a defect, in the defect management table. The aforementioned elements are each realized by process executed by the HDC&MCU 10.

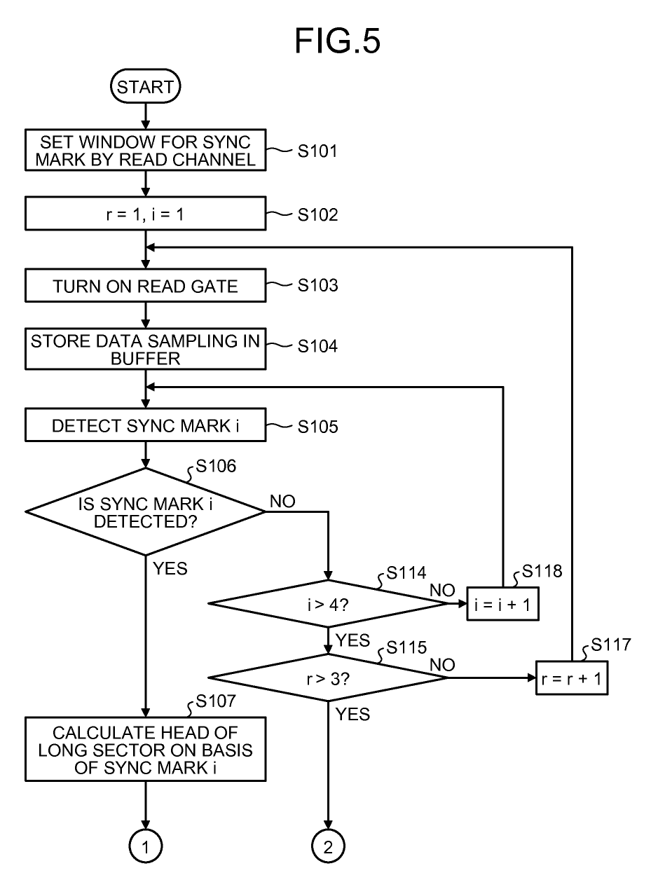

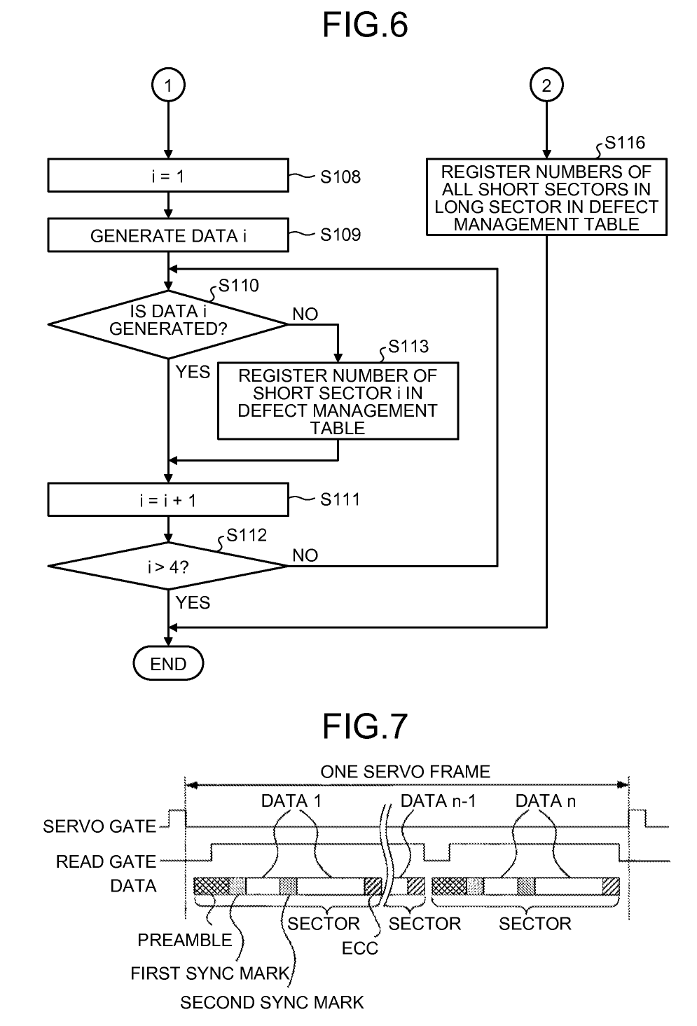

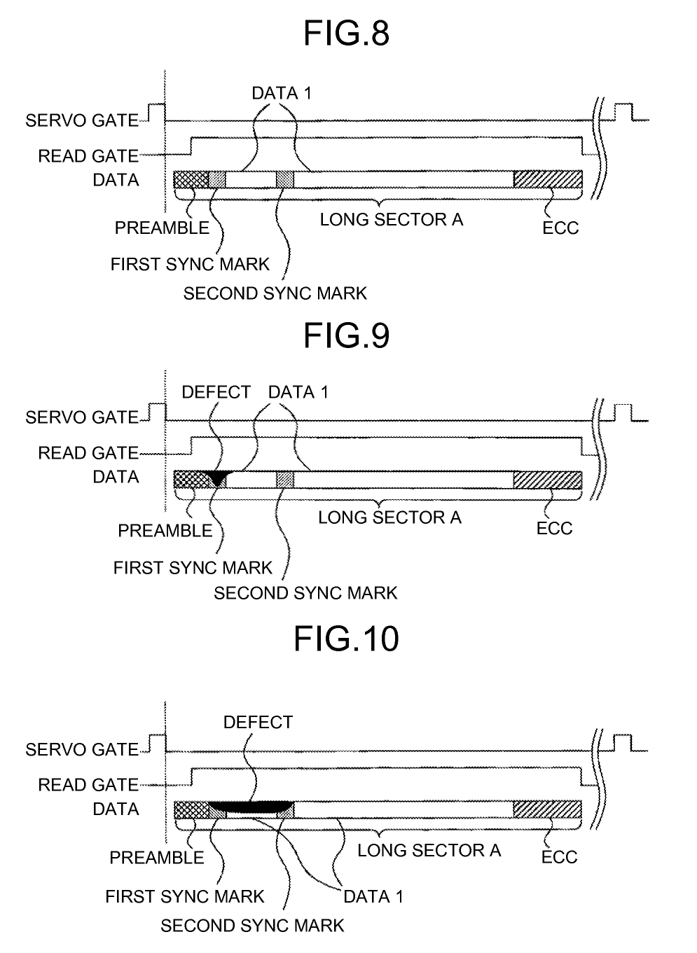

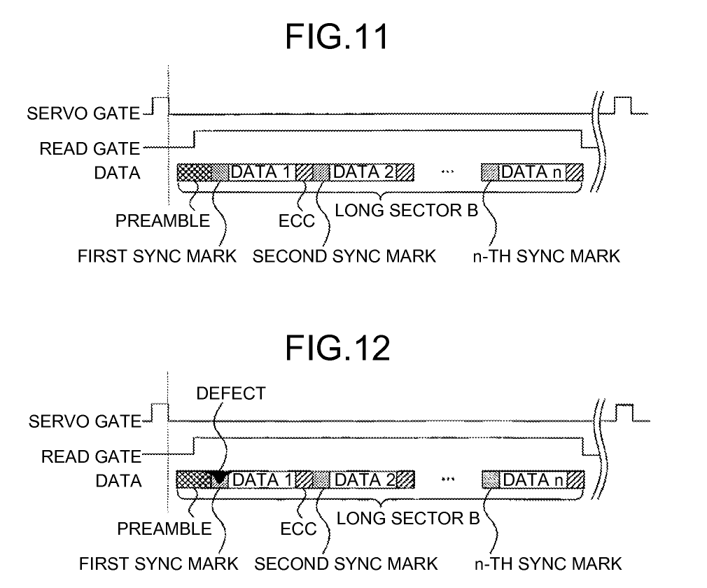

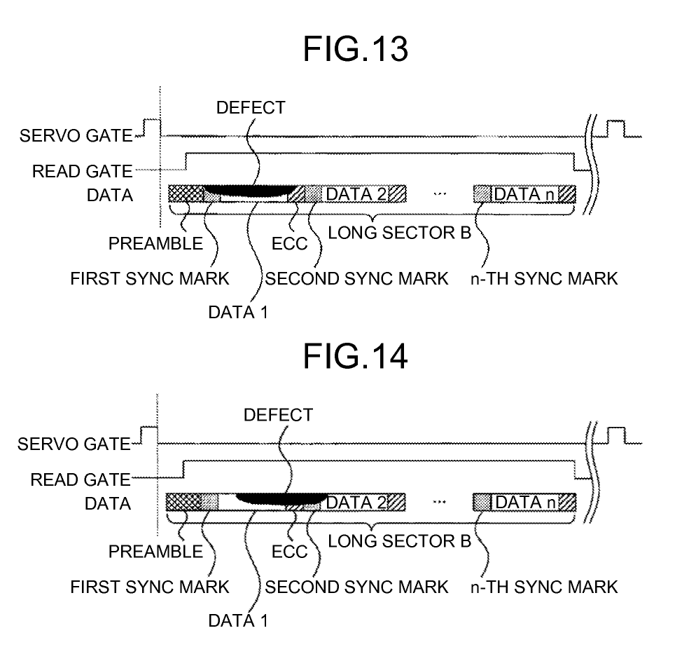

Next, the defect registering process will be described. FIGS. 5 and 6 are flowcharts of the defect registering process. In the process of the flowcharts, for convenience, a certain long sector is set as a target to be processed. However, the defect registering process is executed with respect to all of the long sectors in the magnetic disk 11.

First, the detector 101 sets a window for a sync mark by the read channel 19 (S101), and sets 1 to a variable r used to control a number of retry and to a variable i indicating a number of a sync mark (S102). The variable i is order in the long sector begun with the preamble side. Next, the detector 101 turns on a read gate according to the detection of the preamble, reads the long sector by the head 13 (S103), and stores data sampling in the buffer 21 (S104). The data sampling indicates all short sectors comprised in the long sector to be read. Next, the detector 101 detects the sync mark i in the data sampling stored in the buffer 21 by the read channel 19 (S105), and judges whether the sync mark i is detected (S106).

When the sync mark i is detected (Yes at S106), the determiner 102 determines the head of the long sector excluding the preamble by the read channel 19, on the basis of the sync mark i (S107).

If the head of the long sector is determined by the determiner 102, the generator 103 sets 1 to i (S108), and generates data i that is data corresponding to the sync mark i (S109). Next, the generator 103 judges whether the data i is normally generated (S110). In the judgment, when the data i is successfully corrected by the ECC attached to the data i or when the data i does not need to be corrected by the ECC, the generator 103 judges that the data is normal.

When the data i is normally (Yes at S110), the generator 103 adds 1 to i to set a new value i (S111), and judges whether the new value i is larger than 4 (S112). Here, 4 is the number of short sectors in the long sector.

When i is larger than 4 (Yes at S112), the generator 103 completes the defect registering process with respect to the target long sector.

Meanwhile, when i is not larger than 4 (No at S112), the generator 103 judges again whether the data i is normally generated (S110).

In S110, when the data i is judged to be abnormal (No at S110), the register 104 registers the number of the short sector i comprising the data I, into the defect management table (S113).

In S106, when the sync mark i is not detected (No at S106), the detector 101 judges whether i is larger than 4 (S114). Here, 4 is the number of short sectors in the long sector.

When i is greater than 4 (Yes at S114), the detector 101 judges whether r is less than or equal to 3 (S115). Here, 3 is the number of retries of the detection of the sync mark in the embodiment.

When r is greater than 3 (Yes at S115), the register 104 registers numbers of all short sectors in the long sector in the defect management table (S116), and completes the defect registering process.

Meanwhile, when r is less than or equal to 3 (No at S115), the detector 101 adds 1 to r to set a new value r (S117), and turns on the read gate again according to the detection of the preamble to read the long sector by the head 3 (S103).

In the judgment of S114, when i is less than or equal to 4 (No at S114), the detector 101 adds 1 to i to set a new value (S118), and detects the sync mark i in the data sampling stored in the buffer 21 (S105).

When data is written in the long sector that comprises the short sectors registered in the defect management table, dummy data is written in the short sectors that are registered in the defect management table. The data that is supposed to be written in the short sector to which the dummy data is written is to be written in a next long sector.

As described above, a number of the short sector comprising the abnormal data and numbers of all of the short sectors in the long sector comprising all of the sync marks undetected are registered in the defect management table. Accordingly, only the short sectors that cannot be used in the long sector can be set as an unusable region. As a result, use efficiency of the data region in the storage medium can be improved. A number of retries and a correction ability (length of the ECC used to correct the data) by the ECC during the defect registering process are variable. Accordingly, by decreasing the number of retries and by lowering the correction ability by the ECC, a judgment reference on whether the short sector is normal can be set. For example, by strictly applying the judgment reference at the time of a test of the storage apparatus 1 that is performed before a shipment, the number of short sectors where abnormality is generated in reading data can be decreased, and the number of defective storage apparatuses 1 can be decreased.

The various modules of the systems described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A storage apparatus configured to record a sector in a storage medium, the sector comprising a plurality of data compartments, each data compartment comprising a data region comprising data and a sync mark indicative of a position of the data region, the storage apparatus comprising:
a reader configured to read the sector in the storage medium;
a detector configured to detect the sync mark in the read sector;
a position detector configured to detect the position of the data region of the read sector based on the detected sync mark;
a data generator configured to generate data of the data region at the detected position;
a data anomaly detector configured to detect whether the generated data is abnormal; and
a data compartment recorder configured to record a data compartment in the storage medium identified from other data compartments, the recorded data compartment comprising a data region which comprises the generated data detected as abnormal.

2. The storage apparatus of claim 1, further comprising:
a sync mark determiner configured to determine whether the sync marks in the read sector are detected by the detector,
wherein the data compartment recorder is configured to retry to record the data compartments of the read sector in the storage medium identified from other data compartments when the sync mark determiner determines that at least one sync mark in the read sector is not detected by the detector.

3. The storage apparatus of claim 1,
wherein an error correcting code is attached to the data region,
the data generator is configured to correct an error of the generated data by the error correcting code attached to the data region comprising the generated error when the error has been generated while generating the data of the data region, and
the data anomaly detector is configured to determine that data comprising the error and not corrected by the error correcting code as abnormal.

4. The storage apparatus of claim 3, wherein the length of the error correcting code is variable.

5. The storage apparatus of claim 2, wherein the sync mark determiner is configured to control the reader to read the sector for a predetermined number of times, and to determine that at least one sync mark in the sector is not detected by the detector based on the result of the reading of the sector for the predetermined number of times, when it is determined that the read sync marks in the sector are not detected by the detector.

6. The storage apparatus of claim 5, wherein the predetermined number of times is variable.

7. A control apparatus of a storage apparatus configured to record a sector in a storage medium, the sector comprising a plurality of data compartments, each data compartment comprising a data region comprising data and a sync mark indicative of a position of the data region, the control apparatus comprising:
a detector configured to control a read channel of the storage apparatus to detect the sync mark in the sector read by a reader of the storage apparatus;
a position detector configured to control the read channel to detect the position of the data region of the read sector based on the detected sync mark;
a data generator configured to generate data of the data region at the detected position;
a data anomaly detector configured to detect whether the generated data is abnormal; and
a data compartment recorder configured to control a storage module of the storage apparatus to record a data compartment in the storage medium identified from other data compartments, the recorded data compartment comprising a data region which comprises the generated data detected as abnormal.

8. The control apparatus of claim 7, further comprising:
a sync mark determiner configured to determine whether the sync marks in the read sector are detected by the detector,
wherein the data compartment recorder is configured to control the storage module to retry to record the data compartments of the read sector in the storage medium identified from other data compartments, when the sync mark determiner determines that at least one sync mark in the read sector is not detected by the detector.

9. The control apparatus of claim 7,
wherein an error correcting code is attached to the data region,
the data generator is configured to correct an error of the generated data by the error correcting code attached to the data region comprising the generated error when the error is has been generated while generating the data of the data region, and
the data anomaly detector is configured to determine that data comprising the error and not corrected by the error correcting code as abnormal.

10. The control apparatus of claim 9, wherein the length of the error correcting code is variable.

11. The control apparatus of claim 8, wherein the sync mark determiner is configured to control the reader to read the sector for a predetermined number of times, and to determine that at least one sync mark in the sector is not detected by the detector based on the result of the reading of the sector for the predetermined number of times, when it is determined that the read sync marks in the sector are not detected by the detector.

12. The control apparatus of claim 11, wherein the predetermined number of times is variable.

13. A control method of a storage apparatus configured to record a sector in a storage medium, the sector comprising a plurality of data compartments, each data compartment comprising a data region comprising data and a sync mark indicative of a position of the data region, the control method comprising:
reading the sector in the storage medium;
detecting the sync mark in the read sector;
determining the position of the data region of the read sector based on the detected sync mark;
generating data of the data region at the detected position;
detecting data anomaly whether the generated data is abnormal; and
recording a data compartment in the storage medium identified from other data compartments, the recorded data compartment comprising a data region which comprises the generated data detected as abnormal.

14. The control method of claim 13, further comprising:
determining whether the sync marks in the read sector are detected by the detecting; and
retrying to record the data compartments of the read sector in the storage medium identified from other data compartments, when at least one sync mark in the read sector is not detected.

15. The control method of claim 13,
wherein an error correcting code is attached to the data region, further comprising:
correcting an error of the generated data by the error correcting code attached to the data region comprising the generated error when the error has been generated while generating the data of the data region, and
determining that data comprising the error and not corrected by the error correcting code as abnormal.

16. The control method of claim 15, wherein the length of the error correcting code is variable.

17. The control method of claim 14, further comprising:
reading the sector for a predetermined number of times; and
determining that at least one sync mark in the sector is not detected by the detecting based on the result of the reading of the sector for the predetermined number of times, when it is determined that the read sync marks in the sector are not detected by the detecting.

18. The control method of claim 17, wherein the predetermined number of times is variable.
